(19) United States
(12) Patent Application Publication
(10) Pub. No.: US 2003/0126459 A1
(43) Pub. Date: Jul. 3, 2003

(54) Method of protecting basic input/output system

(76) Inventors: Chin-Jun Kao, Taipei Hsien (TW); Russell Liao, Taipei Hsien (TW)

Correspondence Address: J.C. Patents, Inc., 4 Venture, Suite 250, Irvine, CA, 92618, US

(21) Appl. No.: 10/034,325

(22) Filed: Dec. 28, 2001

(51) Int. Cl. G06F 12/14

(52) U.S. Cl. 713/200

(57) ABSTRACT

A basic input/output system (BIOS) protection method capable of preventing computer virus attack. The method includes setting up a protection function in the basic input/output system. The protection function enables a user to select between protection enable and protection disable. When protection enable is selected, only reading from a set memory holding the BIOS program is permitted. Hence, nothing can be written into the memory. Conversely, if protection disable is selected, data can be written into the set memory. Since protection disable can be selected by user at any time, protection enable is selected by default so that the writing of data into the BIOS memory by computer viruses is prevented.

### BACKGROUND OF THE INVENTION

1. Field of Invention

The present invention relates to a method of preventing computer virus attack. More particularly, the present invention relates to a method of protecting a basic input/output system.

2. Description of Related Art

Rapid development of computer and information technologies has created tremendous changes to our living environment and society. However, some computer experts have also created many kinds of viruses to infect our computers causing chaos to our computer systems. The viruses attack our computers at home and in the office, personal workstation and network servers. Nearly everyone's computer, no matter what type of operating system is installed, is vulnerable to virus attack once the computer is switched on.

Computer virus is a piece of code program than can replicate and spread out to other program files. In general, the virus is spread from a magnetic disk or via a computer network into a compute file. When the virus-infected file is executed, control of the operating system is usurped so that other files are infected too. In this way, files are overlaid or destroyed leading to the production of non-executable files or bringing down the entire system.

To hide inside a program file, the computer virus needs to have a small length of below about 4 KB. Computer viruses mainly attack the booting sector of soft or hard disk, the executable files and word documents. The target and method of infection for a computer virus includes the following: file infection virus, bootstrap sector virus, multi-partite virus and macro virus.

The so-called file infection virus is a type of computer virus that stays parasitically inside an executable file. When a user starts executing the virus-infected file, the virus will be triggered into destroying data or spreading the virus to other programs during execution. The ‘Friday the 13^{th}’ virus belongs to this type of virus. The bootstrap sector virus resides in the system memory of a computer. When the computer is switched on, the system bootstrap sector program is utilized to reproduce and sent to other sections. Finally, the system bootstrap sector program is written back to the system bootstrap sector. Hence, in the presence of bootstrap sector virus, any file reading or writing will trigger the virus into writing into system bootstrap sectors. An example of this type of virus is ‘C-Brain’. The multi-partite virus has both file infection and bootstrap section virus characteristics. An example is the so-called ‘3783 virus’. The files infected with the ‘3783 virus’ will have an additional length of 3783 bytes. The macro virus utilizes the macro functions provided by application software. When the virus-infected document is used, the virus will utilize every opportunity such as opening an old file, opening a new file, storing files to infect other documents, change file names and/or file content and indicate other signals. An example of this type of virus is ‘Taiwan No. 1’.

The aforementioned viruses can initiate countless type of attacks on computers leading to great financial losses. Therefore, many companies that depend on computer or network to carry out their businesses spend so much manpower and effort to prevent the spread of computer virus. However, most virus prevention schemes are software protection methods that use virus-scanning programs to check for any virus codes. In fact, virus scanning is a process of identifying the specific codes of a particular type of virus. The virus code normally has fixed command code sequence. Since a mechanical code rarely has a long sequence of closely linked commands, virus program can be detected by scanning. Nevertheless, the method cannot protect the computer against non-discovered virus. Consequently, virus updating must be constantly carried out. Moreover, software anti-virus protection software can only execute after power on self test (POST) has been executed. Thus, input/output and program storage to the hard drive must be virus-inspected repeatedly leading to time wastage and lowering of computer efficiency.

In addition, following the use of Windows 95 operation system, the adoption of plug and play system, and the drop in price of flash memory, basic input/output system (BIOS) firmware is now commonly designed for loading into the flash memory so that modification can be carried out at any time. Consequently, not only are floppy disks and hard disks vulnerable to virus attack, BIOS firmwares are also subjected to possible virus attack.

Moreover, because the BIOS program is stored inside a flash memory, any change to the content inside the BIOS can be carried out by executing, for example, AWDFLASH.EXE. Through a function call within the BIOS program, BIOS content can be changed. However, other virus program can also use the function call to change the content of the BIOS on the main board BIOS leading to computer breakdown.

### SUMMARY OF THE INVENTION

Accordingly, one object of the present invention is to provide a method of protecting a basic input/output system. A protection list is added to the basic input/output system (BIOS) selection list. Normally, only reading from the BIOS is permitted. Writing into the BIO is disallowed. However, if content within the BIOS needs to be renewed, the protection must be lifted by the user before anything can be written into the BIOS.

To achieve these and other advantages and in accordance with the purpose of the invention, as embodied and broadly described herein, the invention provides a basic input/output system protection method capable of preventing computer virus attack. The method includes setting up protection function in the basic input/output system. The protection function enables a user to select between protection enable and protection disable. When protection enable is selected, only reading from a set memory holding BIOS data is permitted. Hence, nothing can be written into the memory. On the other hand, if protection disable is selected, data can be written into the set memory.

Since a user can select protection disable at any time, default setting is the protection enable so that attack by computer virus is prevented because BIOS internal function call permits reading only and writing is disallowed. In addition, flash memory can be used to hold the BIOS program.

To enable the memory so that data can be written, the following steps are sequentially executed. First, a data input signal is provided. When protection disable is selected, at least one general-purpose output signal is provided. The general-purpose output signal must satisfy a preset logic so that a write signal written into the memory is equivalent to data input signal. On the contrary, when protection enable is selected, the written signal is not equivalent to data input signal and hence cannot write any data into the memory. The preset logic can be a combinatorial logic function designed for inspection such as a simple OR gate function. Alternatively, the preset logic can be a sequential logic function specially designed for logic testing.

With the introduction of the aforementioned hardware for BIOS protection, the moment for writing data into the BIOS is under control. By suitable software control of the hardware protection circuit, abnormal writing into the BIOS is prevented.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing the steps for protecting the basic input/output system according to this invention;

FIG. 2 is a sketch showing a combinatorial logic circuit for controlling the writing of data into the basic input/output system according to this invention; and

FIG. 3 is a sketch showing a method of controlling the writing of data into the basic input/output system using an OR gate according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Because the BIOS program is stored inside a flash memory, any change to the content inside the BIOS can be carried out by executing, for example, AWDFLASH.EXE. Through a function call within the BIOS program, BIOS content can be changed. However, other virus program can also use the function call to change the content of the BIOS on the main board BIOS leading to computer breakdown.

This invention provides a method of protecting BIOS program against virus attack. The step includes setting a protection function inside the BIOS, wherein the protection function can be system parameters stored as data within a CMOS memory. The protection function permits a selection between protection enable and protection disable.

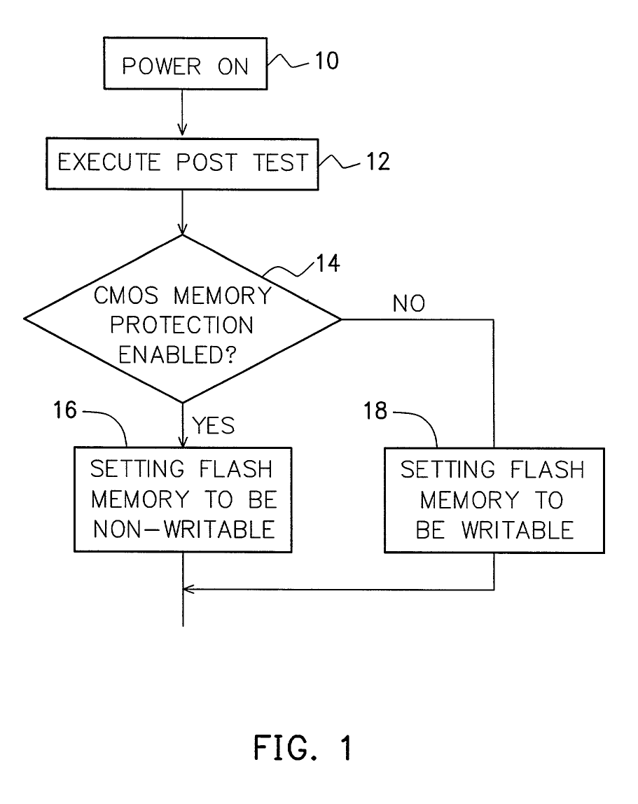

FIG. 1 is a flow chart showing the steps for protecting the basic input/output system according to this invention. In step 10, power is switched on. In step 20, a power on self test (POST) is conducted by the computer. In other words, hardware and peripheral devices attached to the computer such as hard drive, CPU and CD-ROM are tested. In step 14, CMOS memory is checked to determine if protection enable or protection disable is chosen by the user.

When protection enable is found in step 14, data within the BIOS is set such that only reading is allowed. In step 16, writing into the flash memory is disabled so that nothing can be written into the BIOS. Conversely, if protection disable is found in step 14, writing into the flash memory is enabled in step 18. In general, to prevent virus attack, the default setting is protection enable so that data can be read from the BIOS only.

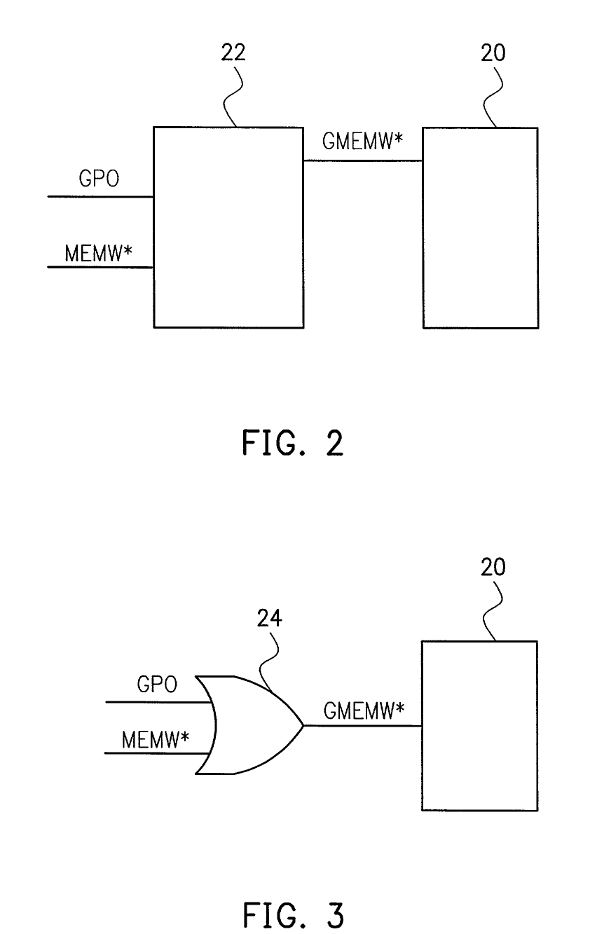

FIG. 2 is a sketch showing a combinatorial logic circuit for controlling the writing of data into the basic input/output system according to this invention. In FIG. 2, a non-volatile memory 20 and a combinatorial logic circuit 22 are shown. The nonvolatile memory 20 is set to be the BIOS. A general-purpose output (GPO) control signal (can consist of a plurality of signals) and data input signal (MEMW*) are input into the combinatorial logic circuit 22. The control signal GPO acts according to the BIOS protection method of this invention, that is, controlled by protection enable or protection disable. The data input signal MEMW* is a signal for controlling the writing of data into the non-volatile memory 20. If the combinatorial logic circuit 22 is implemented using an OR gate as shown in FIG. 3, the OR gate 24 will always output a logic ‘1’ when the GPO signal input is a logic ‘1’. Hence, the data input signal MEMW* cannot input data into the non-volatile memory 20. Conversely, if the GPO signal outputs a logic ‘0’, output GMEMW* of the OR gate 24 will reproduce the signal transmitted at data input signal MEMW* line. Ultimately, the non-volatile memory 20 is able to receive input data. In other words, the memory is in a protection-disable state. In addition, the combinatorial logic circuit in FIG. 2 can be designed as a logic circuit with a sequential logic function.

In summary, basic input/output system of this invention provides a protection enable and a protection disable state so that the protection enable state is selected by default to permit reading from the BIOS only. Hence, the BIOS program is protected from computer virus attack. On the other hand, if content within the BIOS needs to be modified, the user can set the memory holding the BIOS into a protection disable state so that new data can be written into the BIOS.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of protecting a basic input/output system against computer virus attack, comprising the steps of:
setting up a protection function in the basic/input output system, wherein the protection function provides user with a choice of selecting between a protection enable state and a protection disable state;
permitting only the reading of data from a memory for holding BIOS data when the protection enable state is selected so that the writing of data into the memory is disallowed; and
permitting the writing of data into the memory when the protection disable state is selected.

2. The method of claim 1, wherein the step of determining if data can be written into the memory further includes the sub-steps of:
providing a data input signal;
providing at least a general-purpose output signal when the protection disable state is selected, wherein the general-purpose output signal satisfies a preset logic so that a write signal input into the memory is equivalent to the data input signal; and
providing write signal not matching the data input signal when the protection enable state is selected so that data cannot be written into the memory.

3. The method of claim 2, wherein the preset logic uses a combinatorial logic function to carry out inspection.

4. The method of claim 3, wherein the combinatorial logic function includes an OR gate.

5. The method of claim 2, wherein the preset logic uses a sequential logic function to carry out inspection.

6. The method of claim 1, wherein the memory includes flash memory.
